(19) United States
(12) Patent Application Publication
(10) Pub. No.: US 2026/0299699 A1
(43) Pub. Date: Oct. 1, 2026

(54) Virtual Component Positioning in Artificial Reality Via User Engagement and Movement

(71) Applicant: Meta Platforms Technologies, LLC, Menlo Park, CA (US)

(72) Inventors: Michael HARRIS, Bulingame, CA (US); Jesse GUERRERO, El Paso, TX (US)

(21) Appl. No.: 19/092,344

(22) Filed: Mar. 27, 2025

(51) Int. Cl. G06F 3/01

(52) U.S. Cl. CPC G06F 3/017; G06F 3/011

(57) ABSTRACT

Implementations reposition virtual component(s) of an artificial reality environment via an applied transformation to a user's location with respect to the virtual component(s). For example, the repositioning applied via the transformation can be based on a user repositioning action, such as a gesture that includes an engagement portion and a movement portion. The transformation can apply positional changes to the user's relative location that are based on the user's movements during the repositioning action. The change to the user's relative location with respect to the virtual components can be perceived, from the user's perspective, as a change to the display locations of the virtual component(s) within the artificial reality environment displayed to the user. Because display of the artificial reality environment, to the user, continues to be from the user's perspective, the change to the user's relative location is viewed, by the user, as a change to the display location(s) of the virtual component(s).

### TECHNICAL FIELD

The present disclosure is directed to repositioning virtual components during an artificial reality session.

### BACKGROUND

Artificial reality systems have grown in popularity and this trend is expected to accelerate. Augmented reality or mixed reality applications can provide interactive three-dimensional experiences that combine the real-world environment with virtual objects. On the other hand, virtual reality applications can provide an entirely self-contained 3D computer environment. Augmented reality, mixed reality, and virtual reality experiences can be observed by a user through a head-mounted display, such as glasses or a headset.

Artificial reality environments can also support virtual social interactions among users. For example, shared artificial reality environments can present remote users an opportunity to interact via a digitally supported environment and/or co-located users an opportunity to augment in-person experiences with digital components. Supporting shared artificial reality experiences increases the utility of artificial reality systems and improves the user experience under a variety of usage scenarios.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a conceptual diagram illustrating multiple users located in different real-world environments that are immersed in a shared artificial reality.

FIG. 6 is a diagram illustrating a shared artificial reality for multiple user's perspectives.

FIG. 7 is an example artificial reality environment illustrating virtual components and real-world components.

FIG. 8 is an example artificial reality environment illustrating repositioned virtual components.

FIG. 9 is a flow diagram illustrating a process used in some implementations of the present technology for repositioning virtual components during an artificial reality session.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to positioning virtual components during an artificial reality session, such as via user engagement and movement that performs the repositioning. An artificial reality environment can be displayed to a user, where the user and virtual component(s) (e.g., virtual objects, an avatar of a second user, etc.) of the environment can comprise locations with respect to the environment (e.g., virtual positions relative to the space of the environment). Implementations can reposition the virtual component(s) of the artificial reality environment via an applied transformation to a user's location with respect to the virtual component(s).

For example, the repositioning applied via the transformation can be based on a user repositioning action, such as a gesture that includes an engagement portion (e.g., grabbing, pinching, etc.) and a movement portion (e.g., while holding the grab, pinch, etc.). The transformation can apply positional changes to the user's relative location that are based on the user's movements during the repositioning action. In some implementations, the repositioning action can be taken via a virtual component of the artificial reality environment. For example, the virtual component can be engaged by the engagement portion and the reposition can be calibrated according to the movement portion. The change to the user's relative location with respect to the virtual components can be perceived, from the user's perspective, as a change to the display locations of the virtual component(s) within the artificial reality environment displayed to the user. Because display of the artificial reality environment, to the user, continues to be from the user's perspective, the change to the user's relative location is viewed, by the user, as a change to the display location(s) of the virtual component(s).

In some implementations, the artificial reality environment that hosts the repositioning can be a shared artificial reality environment. For example, a version of the shared artificial reality environment can be displayed to multiple users. Shared artificial reality environments can include a virtual reality environment, in which multiple users are immersed in a same virtual reality environment. In another example, a shared artificial reality environment can be a mixed reality or augmented reality environment, in which the versions of the shared artificial reality environment, as displayed to the users, comprise one or more shared virtual component(s) and different real-world components (e.g., based on the real-world surroundings for each user/artificial reality system). A shared mixed reality or augmented reality environment can comprise some shared virtual component(s) and some virtual component(s) that are not shared, such as a user presence (e.g., avatar) for each user.

In some implementations, the repositioning of a first user with respect to virtual components can be part of a shared XR environment. For example, the shared XR environment can be displayed to a first user, including displaying virtual components, and the shared XR environment can be displayed to a second user, including displaying at least a portion of the virtual components to the first user. In this example, the XR environment displayed to the first user can include an avatar for the second user and a shared virtual object and the XR environment display to the second user can include an avatar for the first user and the shared virtual object. A repositioning action by the first user can alter a relative location of the first user with respect to the shared virtual objects. Accordingly, the display location of the shared virtual objects, as displayed to the first user after repositioning, can change because the XR environment can be displayed from the first user's perspective. On the other hand, the display location of the shared virtual objects, as displayed to the second user after repositioning, may be maintained because this XR environment can be displayed from the second user's perspective. However, a location of the avatar for the first user, as displayed to the second user, can be changed in response to the repositioning.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers. “Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Conventional XR systems permit users to reposition virtual components, such as virtual objects, via different mechanisms, such as grab and move. However, often these repositioning mechanisms breakdown in scenarios that include complexities, such as different versions of a shared XR environment that include some shared virtual components and different real-world components. Implementations provide an improved repositioning technique for repositioning a user's location relative to the virtual components of a shared AR or MR environment. By altering a location of the user, relative to the virtual components, via a repositioning action, the user can move display locations for the virtual components in an efficient and practical manner. In addition, because it is the user's relative location that is altered, shared XR environment(s) displayed to other user(s) can effectively display the shared virtual components without the repositioning causing interference with their display(s).

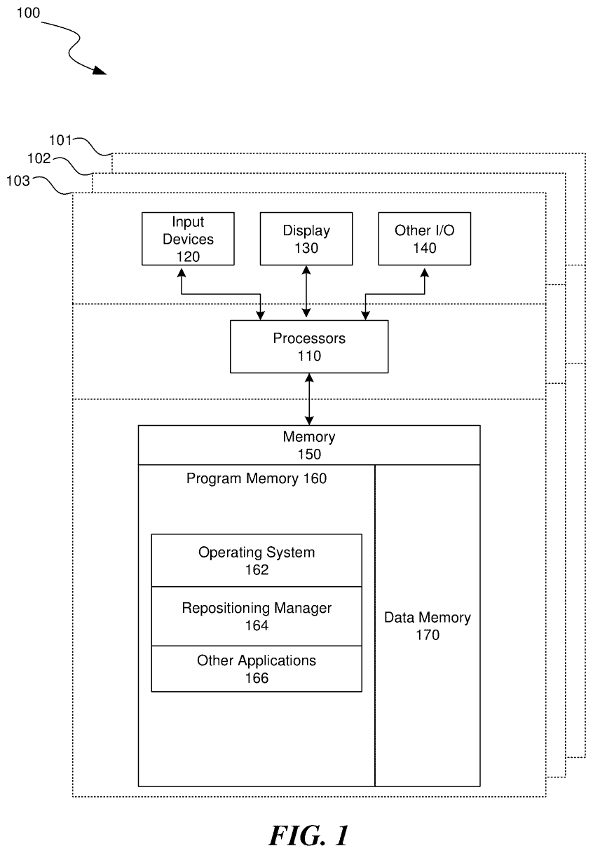

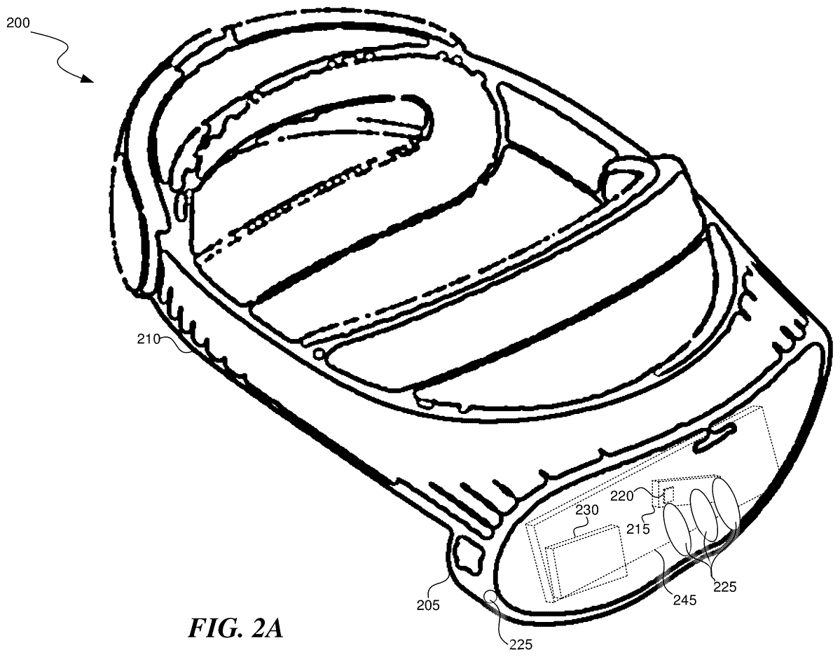

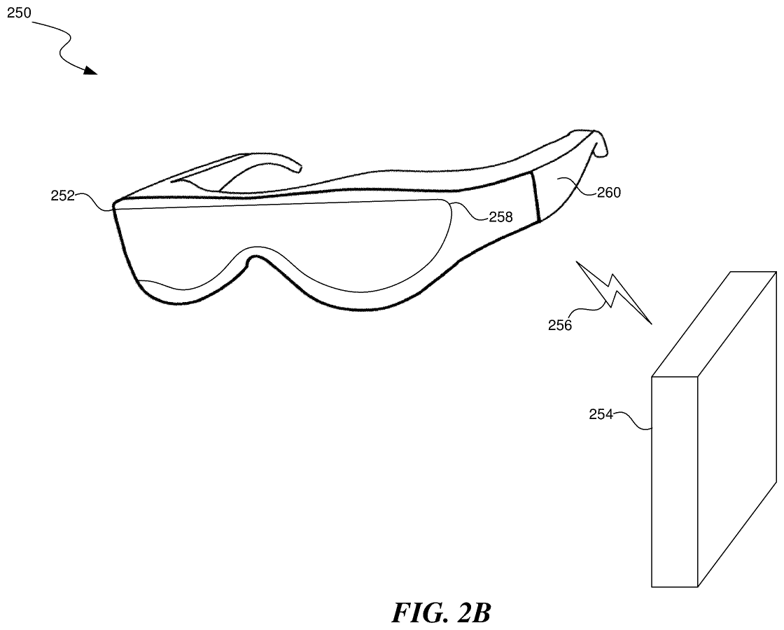

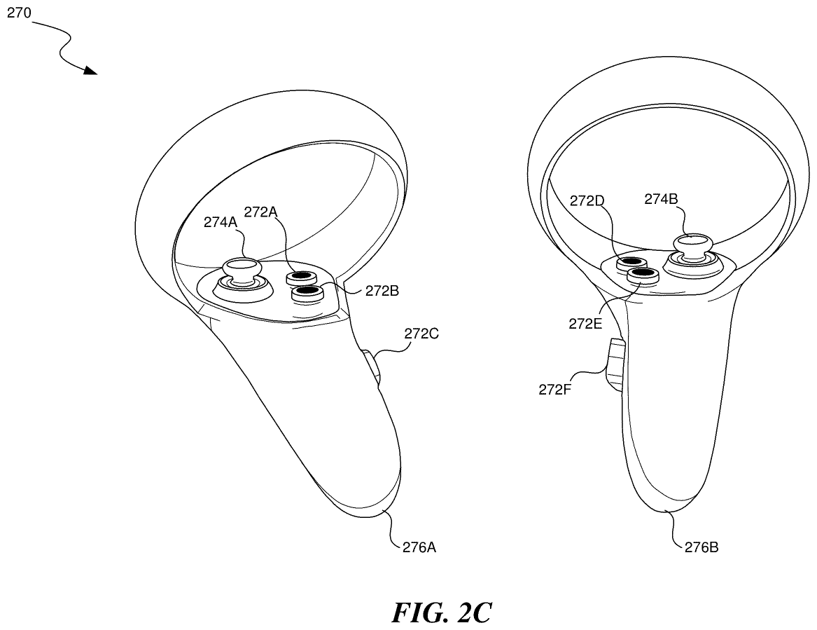

Several implementations are discussed below in more detail in reference to the figures. FIG. 1 is a block diagram illustrating an overview of devices on which some implementations of the disclosed technology can operate. The devices can comprise hardware components of a computing system 100 that repositioning virtual components during an artificial reality session. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, repositioning manager 164, and other application programs 166. Memory 150 can also include data memory 170 that can include, e.g., virtual object data, movement and/or gesture data, shared XR environment data, configuration data, settings, user options or preferences, etc., which can be provided to the program memory 160 or any element of the computing system 100.

In various implementations, the technology described herein can include a non-transitory computer-readable storage medium storing instructions, the instructions, when executed by a computing system, cause the computing system to perform steps as shown and described herein. In various implementations, the technology described herein can include a computing system comprising one or more processors and one or more memories storing instructions that, when executed by the one or more processors, cause the computing system to steps as shown and described herein.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an artificial reality environment in three degrees of freedom (3DoF) or six degrees of freedom (6DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

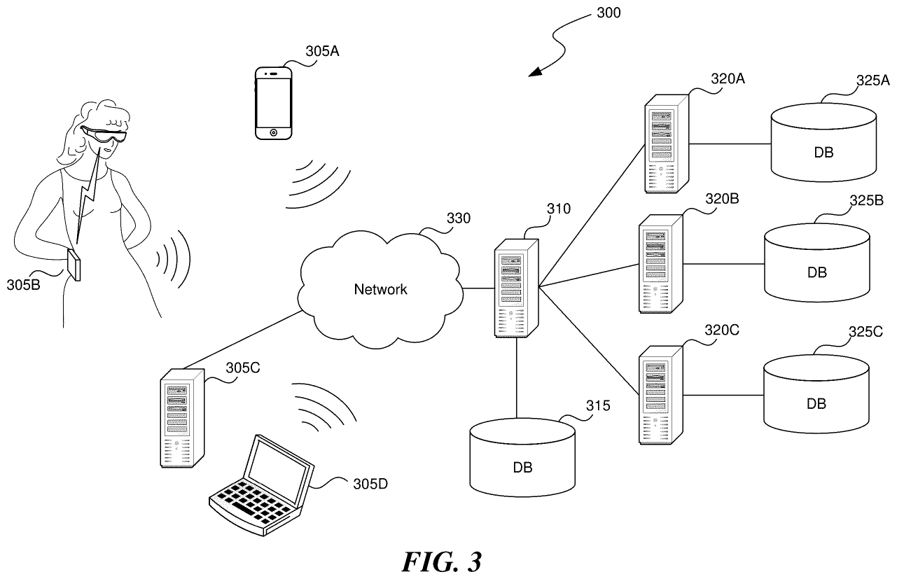

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

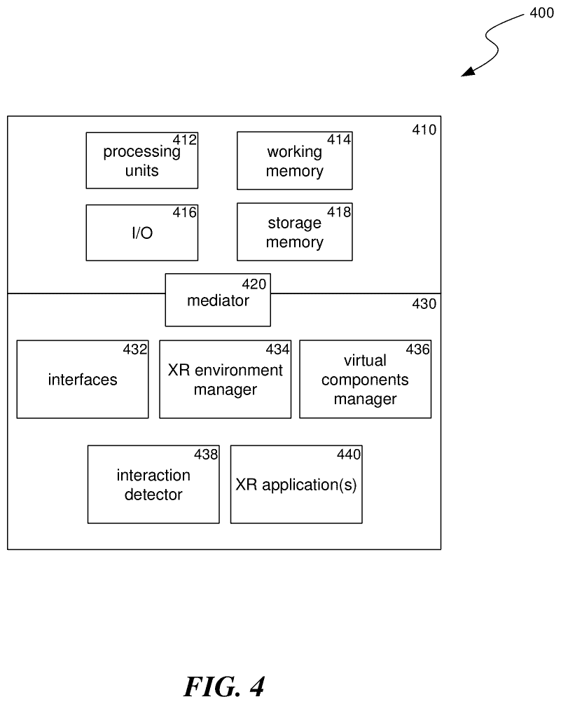

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for repositioning virtual components during an artificial reality session. Specialized components 430 can include XR environment manger 434, virtual components manager 436, interaction detector 438, XR application(s) 440, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

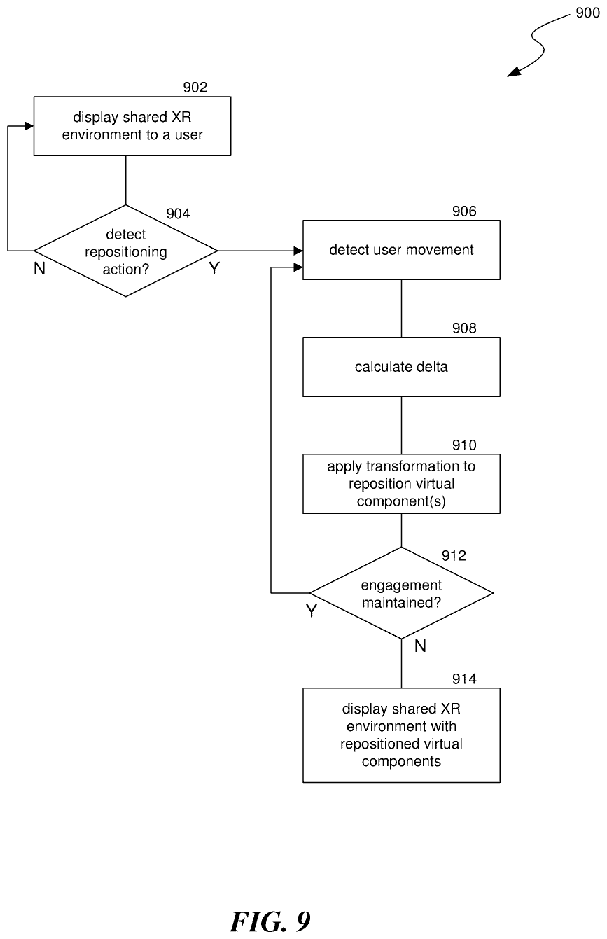

XR environment manger 434 can manage XR environments provided via XR system(s). Example XR environments include VR environments, AR environments, MR, environments, or any combination thereof. In some implementations, XR environment manager 434 can transition between XR environments, such as based on a change in operating mode triggered at an XR system. In some implementations, XR environment manager 434 can manage shared XR environments. For example, a shared XR environment can comprise certain elements that are shared among different XR system users, such as shared virtual components. In these examples, a virtual object can be presented to two different XR users, where each XR user is presented an XR environment that includes the shared virtual object. XR environment manger 434 can be a component of and/or comprise components of a system shell for an XR system. Further details regarding XR environment manger 434 are described with respect to blocks 902, 910, and 914 of FIG. 9.

Virtual components manager 436 can manage virtual objects, such as virtual objects displayed via XR environment(s). Example virtual components include virtual objects, a virtual user presence (e.g., user avatar, user hologram, etc.), and any other suitable virtual component of an XR environment. Virtual components manager 436 can manage display of these virtual components and/or interactions with these virtual components. In some implementations, a virtual object managed via virtual components manager 436 can be shared among different users, such as presented to different users via a shared XR environment. Virtual components manager 436 can be a component of and/or comprise components of a system shell for an XR system. Further details regarding virtual components manager 436 are described with respect to blocks 902, 904, 910, and 914 of FIG. 9.

Interaction detector 438 can detect user actions that trigger interactions with virtual components. Example user actions include gestures, actions that control interface components (e.g., ray cast, virtual hands, hand-held controller movements and/or button presses, etc.), user movement, and any other suitable user actions. User actions detected via interaction detector 438 can involve interactions with virtual components managed via virtual components manager 436. For example, a detected user action may engage and interact with a virtual object in a manner that alters display of the virtual object, display of other virtual components of an XR environment, display of other aspects of an XR environment, or any combination thereof. Interaction detector 438 can be a component of and/or comprise components of a system shell for an XR system. Further details regarding interaction detector 438 are described with respect to blocks 904, 906, 908, 910, and 912 of FIG. 9.

XR application(s) 440 can include applications that execute, at least in part, at the XR system and provide content for display to a user. For example, XR application(s) 440 can provide two-dimensional content and/or three-dimensional content (e.g., non-immersive three-dimensional content) for display in one or more virtual objects positioned in an XR environment managed by XR environment manger 434. In some implementations, XR application(s) 440 can support a shared virtual object presented to multiple users via a shared XR environment. Examples of XR application(s) 440 include gaming applications, productivity applications, web browsers, music players, video players, social media applications, messaging or other communication applications, third-party applications, streaming/casting applications, a content library application, or any other suitable application. Additional details on XR application(s) 440 are provided below in relation to blocks 902, 910, and 914 of FIG. 9.

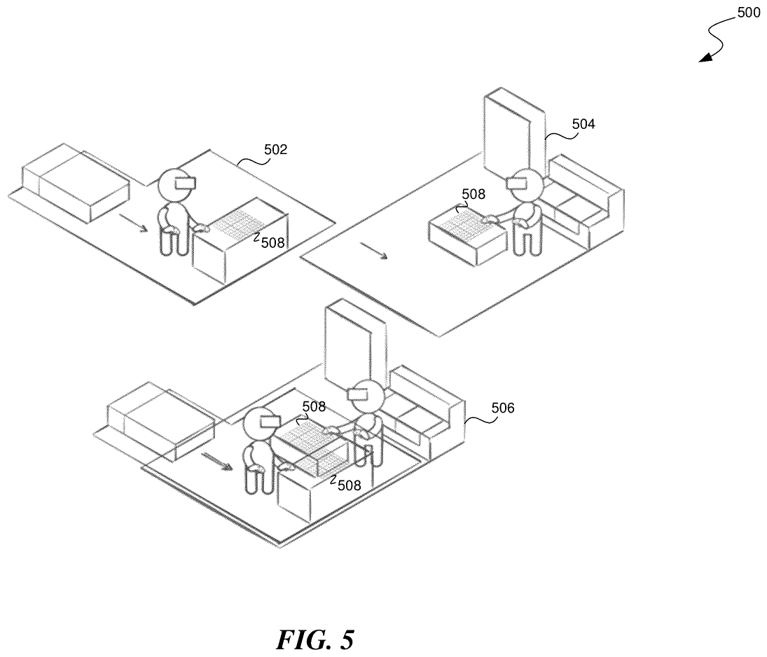

FIG. 5 is a conceptual diagram illustrating multiple users located in different real-world environments that are immersed in a shared artificial reality. Diagram 500 illustrates real-world spaces 502 and 504, combined space 506, and virtual object 508. Real-world spaces 502 and 504 each represent a different room in which a user operates an XR system. For example, the XR systems may immerse these two users in a shared XR environment. Thus, while these users are remote from one another, the XR environments displayed to each user may comprise at least some shared components. In the illustrated example, a shared component can be virtual object 508.

In some implementations, the shared XR environment may be an AR or MR environment. In such a scenario, while virtual object 508 can be shared in the XR environments presented to the users, the real-world locations that relate to virtual object 508 may be different. For example, in real-world space 502 virtual object 508 is located proximate to a desk near a bed, while in real-world space 504 virtual object 508 is located proximate to a table near a sofa. Combined space 506 is a conceptual rendering that illustrates a combination of real-world spaces 502 and 504. In the conceptual rendering, combined space 506 illustrates the different locations for virtual object 508. The example illustrated by combined space 506 demonstrates challenge(s) with a shared XR environment presented to multiple users, in different real-world settings.

At least one of these challenges relates to positioning of virtual object 508 and/or positioning of other virtual components of the shared XR environment, such as avatars for each user. For example, the different real-world settings can present a unique set of challenges with respect to positioning virtual components. Implementations position virtual components of a shared XR environment via user engagement and movement in a manner that mitigates the challenges illustrated by combined space 506 of FIG. 5.

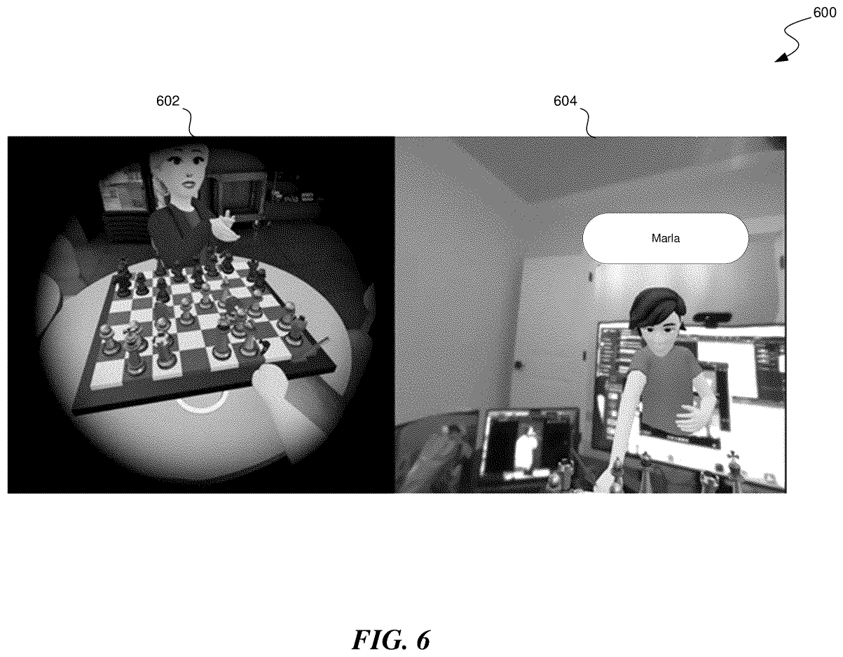

FIG. 6 is a diagram illustrating a shared artificial reality for multiple user's perspectives. Shared XR environment 600 illustrates presented XR environment 602, and presented XR environment 604. With reference to the example provided with reference to FIG. 5, two different XR system users that are immersed in a shared XR environment may occupy different rooms with different real-world surroundings. Each user may be presented a version of the shared XR environment with some shared components and some components that are not shared. Presented XR environment 602 may be displayed to a first user and presented XR environment 604 may be displayed to a second user.

Presented XR environment 602 can comprise a shared virtual object, which is a chess board in the illustrated example, and an avatar for the second user. Similarly, presented XR environment 604 can comprise the shared virtual object and an avatar for the first user. A shared component within presented XR environment 602 and presented XR environment 604 can be the chess board virtual object. Components of each XR environment that are not shared can be the real-world surroundings in each room, as well as the user avatars. Each of presented XR environment 602 and presented XR environment 604 include an avatar, but these avatars represent different users.

As illustrated in diagram 600, because each user/XR system is located in a different room, the chess board virtual object is located in different places in each of presented XR environment 602 and presented XR environment 604. Moreover, each avatar included in XR environment 602 and presented XR environment 604 is located near the chess board virtual object to support gameplay. In some scenarios, virtual components and real-world components of a shared XR environment may interfere with one another. For example, some of these virtual component(s) are shared, others of these virtual component(s) locations may comprise restrictions for practicality (e.g., restricted to a distance near the shared virtual component), and the real-world components in each presented XR environment are different. Implementations provide positioning techniques to reposition virtual components in such a shared XR environment, for example to improve cohesion with the different real-world settings and to support practical virtual component placement.

Implementations reposition virtual component(s) of an XR environment via an applied transformation to a user's relative location with respect to the virtual component(s). For example, the repositioning applied via the transformation can be based on a user repositioning action, such as a gesture that includes an engagement portion and a movement portion. The transformation can apply positional changes to the user's relative location that are based on the user's movements during the repositioning action. In some implementations, the repositioning action can be taken via a virtual component of the XR environment. For example, the virtual component can be engaged by the engagement portion and the repositioning action can be calibrated according to the movement portion. The change to the user's relative location with respect to the virtual components can be perceived, from the user's perspective, as a change to the display locations of the virtual component(s) within the XR environment displayed to the user. Because display of the XR environment, to the user, continues to be from the user's perspective, the change to the user's relative location is viewed, by the user, as a change to the display location(s) of the virtual component(s).

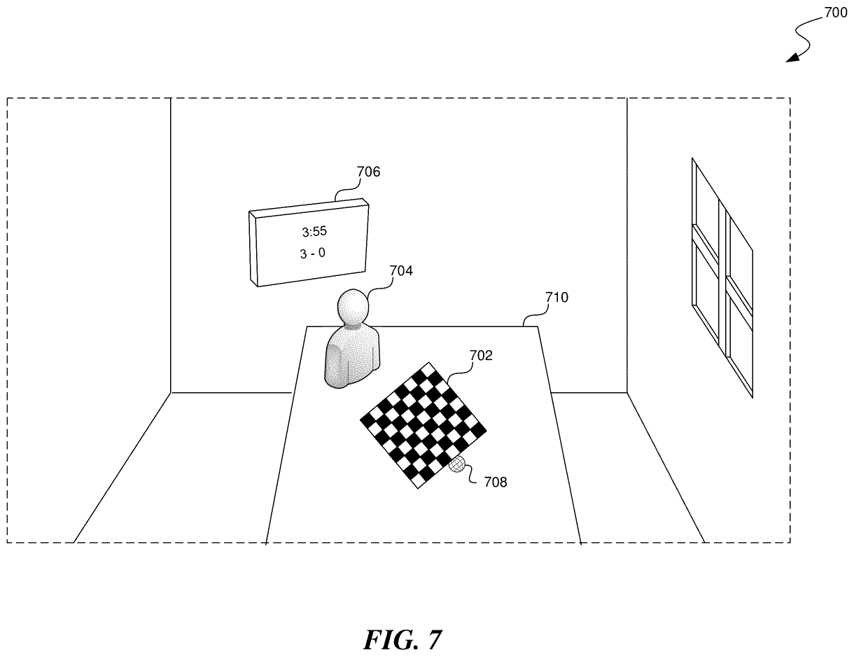

FIG. 7 is an example artificial reality environment illustrating virtual components and real-world components. XR environment 700 illustrates virtual object 702, user presence 704, virtual object 706, repositioning element 708, and real-world object 710. XR environment 700 can be displayed to a first user via a first XR system. In some implementations, XR environment 700 displayed to the first user can be part of a shared XR environment. For example, user presence 704 can be a digital representation of a second user (e.g., avatar, hologram, etc.) that is part of the shared XR environment.

Virtual object 702 can be an interactive virtual object, such as a virtual object that is part of a gaming XR application or any other suitable virtual object that can be interacted with by a user. Virtual object 702 can be an object related to virtual object 706. In the illustrated example, virtual object 702 supports a digital board game and virtual object 706 displays content related to a game played via virtual object 702. In some implementations, content for virtual objects 702 and/or 706 can be provided by XR application(s) executing at XR system(s). XR environment 700 can comprise an AR or MR environment with real-world components, such as a real-world object 710. In the illustrated example, virtual object 702 is situated on a tabletop of real-world object 710.

In some implementations, virtual object 702 and/or virtual object 706 can be part of the shared XR environment. For example, the second user can be displayed the shared XR environment, via a second XR system, and the XR environment displayed to the second user can comprise at least some shared components, such as virtual object 702 and/or virtual object 706. In some implementations, the XR environment displayed to the second user can also be an AR or MR environment, and thus the virtual components of this XR environment can be situated among different real-world components than the virtual components of XR environment 700 (displayed to the first user). In some implementations, the XR environment displayed to the second user can be a VR environment.

In some implementations, repositioning of virtual components of XR environment 700, from the first user's perspective, may improve the first user's experience. For example, interference between the real-world components and the virtual components of XR environment 700 can be mitigated via the repositioning. The repositioning can improve any other suitable issues with respect to how the first user perceives and/or interacts with XR environment 700. Implementations support repositioning via user engagement with repositioning element 708 and user movement during this engagement. Repositioning element 708 can be a part of virtual object 702 and/or a separate virtual component. Repositioning element 708 can be an engageable virtual component, such as a virtual disk or ring, a virtual knob, a virtual handle, a virtual hook, or any suitable engageable virtual component. In some implementations, repositioning element 708 can be a mere indicator and the first user can engage with virtual space indicated by repositioning element 708 to perform the repositioning.

The first user can engage with repositioning element 708 in any suitable manner. For example, a repositioning action by the first user can include an engagement portion and a movement portion. User interface channels that support interaction between the first user and virtual components of XR environment 700 include virtual hands, a ray cast (e.g., ray cast towards XR environment 502 from the user/user's body, such as the user's wrist), any other suitable collider, or any other suitable interactive element. The engagement portion of a repositioning action, which can engage repositioning element 708, can include: a user gesture (e.g., a user grab, pinch, hand closure, etc.), a targeting and selection action (e.g., targeting via a ray and selection via a gesture, button press on a hand-held controller, etc.), and any other suitable user action that engages a virtual element.

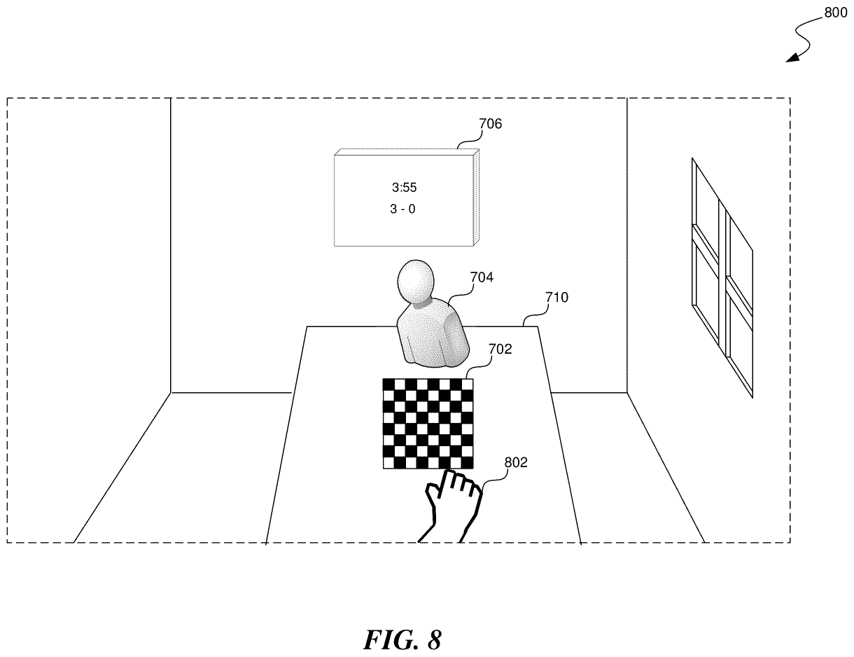

In some implementations, once the first user engages repositioning element 708, the user can perform a movement portion of a repositioning action. The movement portion can involve movement along a line or arc, or any other suitable three-dimensional movement. The movement portion can cause an adjustment to the display locations for user presence 704, virtual object 706, and/or virtual object 702. In some implementations, the movement portion can cause application of a transformation to the relative location of the first user with respect to the virtual components of XR environment 700. In this example, because the display of XR environment 700, to the first user, is from the user's perspective, the change to the user's relative location is viewed, by the first user, as a change to the display locations of the virtual components. XR environment 800 of FIG. 8 illustrates repositioned virtual components, from the first user's perspective, after a movement portion of a repositioning action.

FIG. 8 is an example artificial reality environment illustrating repositioned virtual components. XR environment 800 illustrates virtual hand 802, virtual object 702, user presence 704, virtual object 706, and real-world object 710. As comparted to the display locations of user presence 704 and virtual object 706 within XR environment 700 of FIG. 7, the display locations of user presence 704 and virtual object 706 within XR environment 800 have been repositioned. In the illustrated example, the display locations user presence 704 and virtual object 706 within XR environment 800 have been rotated from their original positions.

In some implementations, the movement portion of a repositioning action can include movement along a line or arc that configures a rotation transformation. For example, the first user can engage (e.g., grab) the repositioning element (e.g., repositioning element 708 of FIG. 7) as illustrated by virtual hand 802, and move along a line or arc while maintaining the engagement. The movement along the line or arc can calibrate a rotation transformation based on a delta between an initial position during engagement (e.g., point in time of grab) and a point in time after movement along the line or arc. The delta can be calculated between positions of virtual hand 802 (e.g., location at engagement vs location after movement), positions of repositioning element 708 (e.g., location at engagement vs location after movement), locations with respect to the repositioning action (e.g., the engagement point vs a point after movement), or any other suitable points that are indicative of the movement portion of the repositioning action. In some implementations, the calculated delta between points of the repositioning action can comprise a movement metric, such as a quaternion and/or movement vector.

The movement portion of the repositioning action can calibrate a rotation transformation applied to a relative location of the user with respect to the virtual components of XR environment 700 (e.g., virtual components prior to repositioning). For example, XR environments 700 and 800 can comprise AR or MR environments. The elements of these XR environments, such as the virtual components and the first user, can each comprise virtual positions with respect to the environments. Changes to the display locations of the virtual component(s) of XR environments 700 and 800 can be achieved by altering a relative location of the first user with respect to virtual components (e.g., change to the virtual position of the first user). For example, the rotation transformation can be applied to the relative location of the first user, and from the first user's perspective it will appear as though the virtual component(s) of the XR environment have moved.

XR environment 800 illustrates display locations for user presence 704 and virtual object 706 after a rotation transformation has been applied to the relative location of the first user. For example, an inverse of the movement metric (e.g., quaternion or vector determined based on a delta between points of the repositioning action) can be used to determine the rotation transformation applied to the relative position of the first user. In other words, some implementations apply an inverse of the rotation of a user's hand that is manipulating a repositioning element. The rotation transformation can be a three-dimensional coordinate transformation (e.g., rotation matrix) such that applying the rotation transformation appears to rotate the relative position of the first user.

In some implementations, the determined movement metric can be processed to achieve a rotation (for the virtual components) that is flattened, such as rotation around a single axis. The single axis can correspond to any suitable dimension of the movement metric. In some implementations, the movement metric can be processed to achieve a rotation (for the virtual components) around two axes.

In other examples, the movement portion can be any other suitable user movement in a three-dimensional coordinate system, and the transformation configured in response to this user movement can be any other suitable transformation. For example, vertical movement, lateral movement, straight line movement, or any other suitable movement can correspond to a movement metric that configures a transformation (e.g., applying an inverse of the movement metric) that adjusts the relative position of the first user with respect to the virtual component(s) of an XR environment.

XR environment 700 (prior to repositioning) and XR environment 800 (after repositioning) can comprise any suitable shared XR environment. For example, at least a portion of the virtual components of these XR environments can be displayed to a second user, via a second XR system, located remate from the first user and the first XR system. In the illustrated example, the XR environment displayed to the second user can comprise virtual object 702 and virtual object 706. In addition, the XR environment displayed to the second user can include a virtual user presence for the first user (e.g., a user avatar). The relative repositioning of the first user, with respect to the virtual components, can cause the display location for the virtual presence for the first user within the XR environment displayed to the second user to change. In this example, because the relative location of the first user with respect to the virtual components is altered (rather than the relative locations of the virtual components with respect to the first user) the display locations for the virtual components in the XR environment displayed to the second user can be maintained even in the presence of repositioning.

The change to the display location to the user presence of the first user, can be presented, via the XR environment displayed to the second user, in any suitable manner. For example, the first user presence can be displayed sliding while the repositioning is occurring, the first user presence can be ghosted (e.g., disappeared from the original position and reappeared after repositioning), or any other suitable movement dynamic can be implemented.

In some implementations, two users can be co-located while being immersed in a shared XR environment, and a repositioning action by one of the users can update display locations of the virtual components of the shared XR environment for both users. For example, a first user can engage a repositioning element within the shared XR environment and perform a movement while maintaining the engagement. The movement portion of this repositioning action can correspond to a movement metric, and an inverse of the movement metric can be applied, as a transformation, to the first user's relative location within the shared XR environment. In addition, a similar transformation can also be applied to the second user's relative location within the shared XR environment. For example, the spatial relationship between the first user's location and the second user's location within the shared XR environment can be maintained by applying a similar transformation to both user's locations within the XR environment. The alteration of the users'locations can cause display location changes to the virtual components within the XR environments presented to these users.

In some implementations, user interactions with a repositioning virtual object involve any suitable input channel(s), such as virtual hands, a ray cast (e.g., ray cast towards an XR environment from the user/user's body, such as the user's wrist), any other suitable collider, or any other suitable interactive element. Virtual user hands can be a virtual representation of the user's hands in a XR environment (e.g., sensed via cameras, hand-held controllers, motion sensor(s), wearable sensor(s), and any other suitable sensor(s)) that can directly interact with XR environment elements, such as virtual objects.

Ray-based interactions can involve a projection extended into an XR environment cast from a user's body. In some implementations, a ray projection (i.e., straight line) can be cast from a control point along a casting direction. For example, the control point can be a palm, fingertips, a fist, a wrist, etc., and the casting direction can be along a line that passes through the control point and an origin point, such as a shoulder, eye, or hip. In other implementations, the control point can be based on other tracked body parts such as a user's eye, head, or chest. For example, the control point can be an estimated position of a center of a user's pupil and the origin point can be an estimated position of the center of a user's retina. In some cases, a graphical representation of the ray projection (the whole line or just a point where the ray hits an object) can be displayed in the artificial reality environment, while in other cases the ray projection is tracked by the XR system without displaying the ray projection. In various implementations, the ray projection can extend from the control point until it intersects with a first object or the ray projection can extend through multiple objects. In some implementations, the direction of the ray projection can be adjusted to “snap” to objects that it is close to intersecting or the ray projection can be curved up to a threshold amount to maintain intersection with such objects.

A repositioning action that interacts with a virtual object associated with repositioning can be performed via any suitable XR system input channel. For example, virtual hand(s) can engage the virtual object and sensed movement from the user while the virtual hand(s) engage the virtual object can cause the repositioning of virtual components. In another example, a ray-based input element can engage the virtual object and sensed movement from the user while the ray-based input element engages the virtual object can cause the repositioning of virtual components. Input from a user via any other suitable input channel(s) can similarly reposition virtual component(s) of an XR environment.

Those skilled in the art will appreciate that the components illustrated in FIGS. 1-8 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 9 is a flow diagram illustrating a process used in some implementations of the present technology for repositioning virtual components during an artificial reality session. In some implementations, process 900 can be performed by an XR system or any other suitable system configured to display a shared XR environment to a user. In some implementations, process 900 can be triggered when virtual component(s) are displayed to a user in an XR environment.

At block 902, process 900 can provide a shared XR environment to a user. For example, the shared XR environment can comprise multiple users, each of which is displayed a version of the shared XR environment via an XR system. In some implementations, the multiple users can be remote from one another. The shared XR environment, as provided to the first user via a first XR system, can include displayed virtual components of the shared XR environment and real-world components (e.g., real-world surroundings of the first XR system). Similarly, the shared XR environment, as displayed to a second user, can comprise at least a portion of the virtual components displayed to the first user and other real-world components (e.g., real-world surroundings of a second XR system).

At block 904, process 900 can detect a repositioning action performed by a user. For example, the repositioning action can be detected by analyzing data captured via the first XR system (e.g., visual data, sensor data, etc.). In some implementations, the repositioning action can include an engagement portion and a movement portion. The engagement portion can be pinch gesture, grab gesture, hand closure gesture, any combination thereof, or any other suitable gesture. In some implementations, the engagement portion comprises a gesture that engages a virtual object, of the virtual components, associated with repositioning. When a repositioning action is detected, process 900 can progress to block 906. When a repositioning action is not detected, process 900 can loop back to block 902 until a repositioning action is detected.

At block 906, process 900 can detect user movement. For example, the repositioning action can include an engagement portion and a movement portion. In some implementations, the movement portion can include detected user movement while the user holds the engagement portion. An example movement portion comprises movement along a line or arc. The movement portion can comprise any other suitable user movement while holding the engagement portion.

At block 908, process 900 can calculate a delta with respect to the user movement. For example, a movement metric can be calculated for the movement portion. In some implementations, the movement metric represents the movement along the line or the arc, such as a vector or quaternion that represents the movement portion of the repositioning action. A movement metric can be any other suitable metric and correspond to any other suitable movement that is part of the movement portion of the repositioning action. The movement metric can be calculated based on a delta between a first position associated with the engagement portion and a second position associated with the movement portion. The first position can be a position, at a time of engagement of a) the virtual object, b) a hand or virtual hand of the first user, or c) any combination thereof, and the second position can be an updated position, after movement via the movement portion, of d) the virtual object, e) the hand or virtual hand of the first user, or f) any combination thereof.

At block 910, process 900 can apply a transformation to reposition virtual component(s). For example, the repositioning can alter, within the shared XR environment as provided to the first user, a relative position of the first user with respect to the virtual components. The repositioning can be performed by applying a transformation to the position of the first user. In some implementations, the applied transformation can be based on the calculated movement metric. For example, the transformation can be determined, at least in part, based on an inverse of the calculated movement metric. In some implementations, the movement metric can represent a multi-dimensional rotation (e.g., quaternion), and the movement metric can be processed to flatten the multi-dimensional rotation such that the applied transformation (e.g., inverse of the processed movement metric) appears to rotate (from the perspective of the first user) the virtual components around a single axis or around two axes. In some implementations, the repositioning alters, within the shared XR environment as provided to the first user, display locations of the virtual components relative to real-world components from a perspective of the first user.

At block 912, process 900 can determine whether engagement is maintained. For example, the repositioning action may comprise a gesture that engages a virtual object in the shared XR environment displayed to the first user. While the user maintains the gesture (e.g., grab, pinch, etc.), the engagement can be maintained. The engagement can be ended when the user no longer maintains (e.g., holds) the gesture. When engagement is maintained, process 900 can loop back to block 906. For example, blocks 906, 908, and 910 can be performed until the engagement is no longer maintained. When engagement is not maintained, process 900 can progress to block 914.

At block 914, process 900 can display a shared XR environment with repositioned virtual components. For example, the repositioning can alter, within the shared XR environment as provided to the first user, a relative position of the first user with respect to the virtual components. The alteration of the relative position of the first user with respect to the virtual components can cause the display locations of the virtual components within the shared XR environment, as displayed to the first user, to move from the perspective of the first user

In some implementations, the repositioning also alters a location for a first user presence provided to the second user of the shared XR environment. For example, the virtual components of the shared XR environment, as displayed to the first user, can include at least an interactive virtual object and a virtual presence for the second user, and the virtual components of the shared XR environment, as displayed to the second user, can include at least the interactive virtual object and a virtual presence for the first user. The shared XR environment, as displayed to the second user, can display, based on the performed repositioning, a position change for the virtual presence for the first user. For example, the position change can be displayed via sliding the virtual presence for the first user, ghosting the virtual presence of the first user (e.g., disappeared from the original position and reappeared after repositioning), or via any other suitable manner.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for repositioning virtual components during a shared artificial reality (XR) session, the method comprising:
providing, via an XR system, the shared XR environment to a first user,
wherein the shared XR environment, as provided to the first user via the XR system, comprises displayed virtual components of the shared XR environment, and
wherein the shared XR environment is provided to a second user;
detecting, via the XR system, a repositioning action performed by the first user, the repositioning action comprising movement along at least a line or an arc;
repositioning, in response to the detected repositioning action, the virtual components of the shared XR environment as provided to the first user,
wherein the repositioning alters, within the shared XR environment as provided to the first user, a relative position of the first user with respect to the virtual components,
wherein the relative position of the first user with respect to the virtual components is altered by applying at least a rotation transformation based on the movement along at least the line or the arc, and
wherein the repositioning alters, within the shared XR environment as provided to the first user, display locations of the virtual components relative to real-world components from a perspective of the first user.

2. The method of claim 1,
wherein the repositioning action comprises an engagement portion and a movement portion that corresponds to the movement along at least the line or the arc,
wherein the engagement portion comprises a gesture that engages a virtual object, of the virtual components, associated with repositioning, and
wherein the alteration of the relative position of the first user with respect to the virtual components causes the display locations of the virtual components within the shared XR environment, as displayed to the first user, to move from the perspective of the first user.

3. The method of claim 2, wherein the gesture comprises a pinch gesture, grab gesture, hand closure gesture, or any combination thereof.

4. The method of claim 2, wherein a movement metric is calculated for the movement along the line or the arc, and the applied rotation transformation is based on the calculated movement metric.

5. The method of claim 4,
wherein the movement metric is calculated as a delta between a first position associated with the engagement portion and a second position associated with the movement portion,
wherein the first position comprises a position, at a time of engagement of a) the virtual object, b) a hand or virtual hand of the first user, or c) any combination thereof, and
wherein the second position comprises an updated position, after movement via the movement portion, of d) the virtual object, e) the hand or virtual hand of the first user, or f) any combination thereof.

6. The method of claim 5, wherein the applied rotation transformation is determined, at least in part, using an inverse of the calculated movement metric.

7. The method of claim 1,
wherein the virtual components comprise at least an interactive virtual object and a virtual presence for the second user, and
wherein the shared XR environment, as displayed to the second user via a second XR system, comprises the interactive virtual object and a virtual presence for the first user.

8. The method of claim 7, wherein the shared XR environment, as displayed to the second user via the second XR system, displays, based on the performed repositioning, a position change for the virtual presence for the first user.

9. A computer-readable storage medium storing instructions, for repositioning virtual components during an artificial reality (XR) session, the instructions, when executed by an XR system, cause the XR system to:
provide the XR environment to a first user,
wherein the XR environment, as provided to the first user via the XR system, comprises displayed virtual components of the XR environment;
detect a repositioning action performed by the first user;
reposition, in response to the detected repositioning action, the virtual components of the XR environment as provided to the first user,
wherein the repositioning alters, within the XR environment as provided to the first user, a relative position of the first user with respect to the virtual components, and
wherein the repositioning alters, within the XR environment as provided to the first user, display locations of the virtual components relative to real-world components from a perspective of the first user.

10. The computer-readable storage medium of claim 9,
wherein the repositioning action comprises an engagement portion and a movement portion that corresponds to movement along at least a line or arc,
wherein the engagement portion comprises a gesture that engages a virtual object, of the virtual components, associated with repositioning, and
wherein the alteration of the relative position of the first user with respect to the virtual components causes the display locations of the virtual components within the XR environment, as displayed to the first user, to move from the perspective of the first user.

11. The computer-readable storage medium of claim 10, wherein the gesture comprises a pinch gesture, grab gesture, hand closure gesture, or any combination thereof.

12. The computer-readable storage medium of claim 10,
wherein a movement metric is calculated for the movement along the line or the arc, and
wherein altering, within the XR environment as provided to the first user, the relative position of the first user with respect to the virtual components is performed by applying a rotation transformation that is based on the calculated movement metric.

13. The computer-readable storage medium of claim 12,
wherein the movement metric is calculated as a delta between a first position associated with the engagement portion and a second position associated with the movement portion,
wherein the first position comprises a position, at a time of engagement, of a) the virtual object, b) a hand or virtual hand of the first user, or c) any combination thereof, and
wherein the second position comprises an updated position, after movement via the movement portion, of d) the virtual object, e) the hand or virtual hand of the first user, or f) any combination thereof.

14. The computer-readable storage medium of claim 13, wherein the applied rotation transformation is determined, at least in part, using an inverse of the calculated movement metric.

15. The computer-readable storage medium of claim 9, wherein the virtual components comprise at least an interactive virtual object and a virtual presence for a second user.

16. The computer-readable storage medium of claim 15, wherein the XR environment, as displayed to the second user via a second XR system, comprises the interactive virtual object and a virtual presence for the first user.

17. The computer-readable storage medium of claim 16, wherein the XR environment, as displayed to a second user via the second XR system, displays, based on the performed repositioning, a position change for the virtual presence for the first user.

18. An artificial reality (XR) system for repositioning virtual components during an XR session, the computing system comprising:
one or more processors; and
one or more memories storing instructions that, when executed by the one or more processors, cause the XR system to:
provide the XR environment to a first user,
wherein the XR environment, as provided to the first user via the XR system, comprises displayed virtual components of the XR environment, and
detect a repositioning action performed by the first user;
reposition, in response to the detected repositioning action, the virtual components of the XR environment as provided to the first user,
wherein the repositioning alters, within the XR environment as provided to the first user, a relative position of the first user with respect to the virtual components, and
wherein the repositioning alters, within the XR environment as provided to the first user, display locations of the virtual components relative to real-world components from a perspective of the first user.

19. The XR system of claim 18,
wherein the repositioning action comprises an engagement portion and a movement portion that corresponds to movement along at least a line or arc,
wherein the engagement portion comprises a gesture that engages a virtual object, of the virtual components, associated with repositioning, and
wherein the alteration of the relative position of the first user with respect to the virtual components causes the display locations of the virtual components within the XR environment, as displayed to the first user, to move from the perspective of the first user.

20. The XR system of claim 19,
wherein a movement metric is calculated for the movement along the line or the arc, and
wherein altering, within the XR environment as provided to the first user, the relative position of the first user with respect to the virtual components is performed by applying a rotation transformation that is based on the calculated movement metric.
